(19) United States
(12) Patent Application Publication
(10) Pub. No.: US 2003/0161485 A1
(43) Pub. Date: Aug. 28, 2003

(54) Multiple beam automatic mixing microphone array processing via speech detection

(75) Inventor: Steven Shawn Smith, Evanston, IL (US)

Correspondence Address: BANNER & WITCOFF, 1001 G STREET N W, SUITE 1100, WASHINGTON, DC, 20001, US

(73) Assignee: Shure Incorporated, Evanston, IL

(21) Appl. No.: 10/083,790

(22) Filed: Feb. 27, 2002

(51) Int. Cl. H04R 3/00; H04R 1/02

(52) U.S. Cl. 381/92; 381/91; 381/77

(57) ABSTRACT

A system and method for tracking and recognizing multiple desired acoustic signals and processing the multiple signals with a single microphone is disclosed. The microphone includes multiple transducer elements, each of which produces a distinct electrical signal. The electrical signal is converted to a digital signal and beamforming and digital signal processing is performed on the electrical signals. The signals are then analyzed for the presence of speech. In the case where speech is present in multiple signals, the speech containing signals are then mixed for outputting.

No claim of priority is made.

### FIELD OF THE INVENTION

This invention relates to microphone signal processing, and, in particular, to recognizing speech signals in single or multiple synchronous beampatterns. The invention allows an array microphone to perform in the place of multiple, separate microphones by treating each beam as the input from a single microphone.

### BACKGROUND OF THE INVENTION

In typical microphone pickup or reception, the sum of the signals received by a particular microphone is undifferentiated. In order to pickup distinct voices or audio sources, multiple microphones are used and are physically separated. In such a system, each microphone is simply processed to focus on the desired audio source, and most typically, the microphone is focused by proximity or direction to the audio source.

Array microphones are known in the field of the art. An array microphone is a single unit where multiple, separate microphones are co-located in a particular arrangement.

As is known in the field of the art, speech detection in a signal utilizes a mixing algorithm. The algorithm uses a short vs. long time averaging process for determining whether speech exists on any of a number (N) channels. The duration of a human speech phenome (the sub-components of speech syllables describing individual movements of the speech tract) is approximately 250 milliseconds. Accordingly, the short term average durations used in speech identification are approximately 250 milliseconds.

Despite the knowledge of speech identification in an audio signal or source, digital signal processing has typically previously required multiple microphones to pickup separate voices.

Previous attempts have been made using signal processing to isolate and process desired sound from other sources. U.S. Pat. No. 4,741,038, to Elko, et al., describes a Sound Location Arrangement, the specification of which is incorporated herein. Elko, et al., describe a signal processing arrangement and microphone array to form at least one directable beam sound receiver. This system is adapted to receive sounds from predetermined locations in a prescribed environment, such as an auditorium. The focus of the application is on a beam formed from a signal coming from a specific location and rejecting sounds outside the prescribed volume. U.S. Pat. No. 4,485,484, to Flanagan, describes a Directable Microphone System, the specification of which is incorporated herein. The system disclosed in this patent uses a plurality of microphone structures with a directable beam, each being directed to a prescribed location. These patents, as noted, require at least one predetermined or prescribed location to be specified for the systems to focus on, and for the systems to reject undesirable sound outside of that location. These systems output sound from only one location at a time, using a second beamformer to scan a predetermined set of locations for speech characteristics.

### BRIEF SUMMARY OF THE INVENTION

The present invention uses multiple transducers or transducer elements in a single unit or single microphone to pickup multiple, separate, distinguishable input signals, each of which is treated independently. The input signals are converted from acoustic signals first to electrical signals and then to digital signals. A beamformer is used that includes a buffer so that the multiple input signals can be used to form multiple beams with multiple directional orientations (steered beams with multiple steering angles). The multiple beams are then analyzed to determine which beams are desired, that is, which beams have a particular specified characteristic. In the preferred embodiment, the specified characteristic is the presence of speech. The desired beams containing speech are then allowed to pass to a mixer which balances the levels and combines the desired beams into an output signal.

In a first embodiment of the present invention, a system for receiving and processing multiple input signals and outputting signals with only a desired characteristic comprising a microphone including multiple transducer elements wherein each transducer element produces a separate electrical signal, a buffer wherein the electrical signals are stored temporarily, a beamformer wherein the electrical signals are formed into a plurality of mutually exclusive signal beams, a desired characteristic detector, and a mixer. The multiple input signals are acoustic signals. The system may include an analog-to-digital converter. The characteristic detector may include a logic block that selects which signal beams are output. The characteristic detector may be a speech detection processor. The signals may be selected based upon the presence of speech in the signal beams. One process the speech detection processor may use is a short versus long time averaging process of the signal envelope for determining whether speech exists. The output signal beams have a directional orientation relative to the microphone. As an alternate implementaiton, multiple beams from the beamformer may be fed to an external automatic mixer such as the Shure SCM810 to auto-mix the desired beams prior to output.

In an exemplary method for isolating and processing multiple desired acoustic signals, the method including receiving input signals with a microphone, the microphone including multiple transducer elements, converting the input signals to electrical signals, storing temporarily the electrical signals in a buffer, forming multiple mutually exclusive beams from the stored electrical signals, selecting desired beams from the complete set of beams, and outputting the desired beams. The method may include the step of converting the electrical signals into digital signals. The method may further include selecting desired beams from the beams by analyzing the beams for a specified characteristic. The specified characteristic may be the presence of speech. The method of selecting the desired beams may include analyzing the beams by first analyzing the beams for intensity and second analyzing the beams for the presence of speech. The method may also include the step of mixing the desired beams prior to said step of outputting.

### BRIEF DESCRIPTION OF THE DRAWINGS

FIG. 1 is a representational view of prior art audio systems for picking up multiple audio sources;

FIG. 2 is a representational view of the system of the present invention employed for picking up multiple audio sources;

FIG. 3 is a representational view of a group of acoustic beams from a pair of respective acoustic audio sources picked up as input;

FIG. 4 is a representational view of acoustic audio beams picked up as input to the system of the present invention; and

FIG. 5 is a schematic representational view of the system of the present invention.

Corresponding reference numerals will be used throughout the several figures of the drawings.

### DETAILED DESCRIPTION OF THE INVENTION

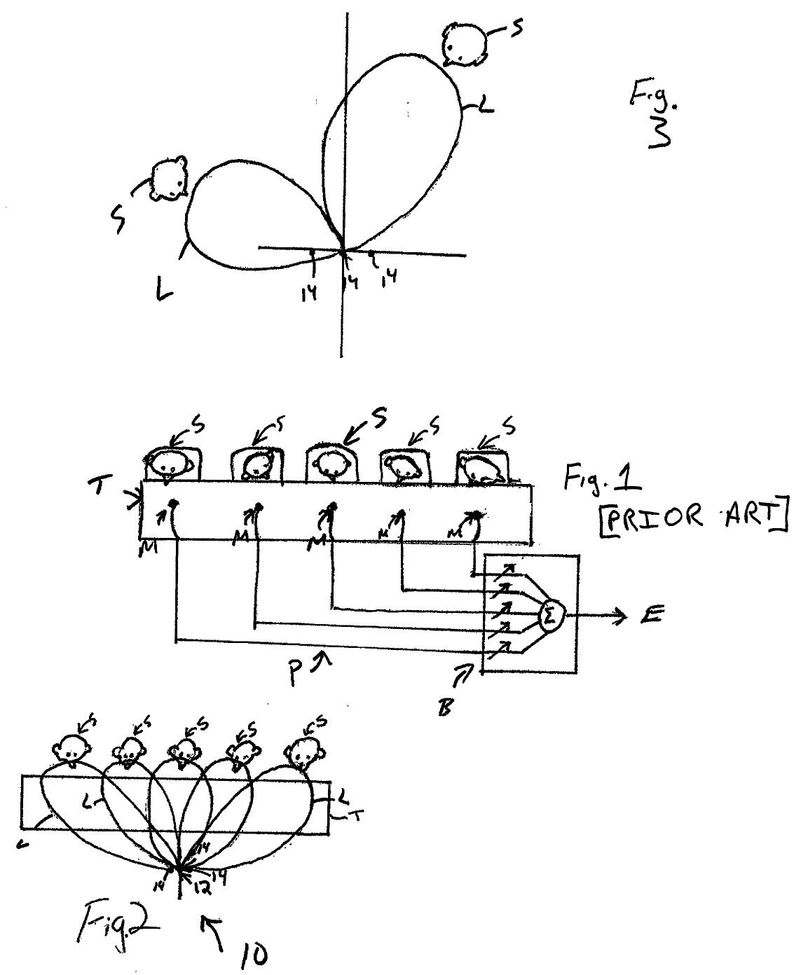

Referring initially to FIG. 1, a typical system P of the prior art for receiving and processing signals from multiple audio sources is depicted. As an example, the system P has 5 microphones M each positioned before a speaker S at a table T, such as a conference table in a conference room. Each microphone M seeks to pick up the acoustic audio signal from each speaker S. The signals received are then processed and mixed by a mixer B. The mixer B furthermore sums the signals and delivers an electrical output signal E. This typical prior embodiment requires a speaker S to be in close proximity to each microphone M and requires processing to eliminate unwanted noise, or speech from nearby speakers S.

Referring now to FIG. 2, the system 10 of the present invention is depicted in use. As depicted, five (5) speakers S are seated at a table T. As each speaker produces an acoustic signal, each acoustic signal is represented here as a lobe L. An acoustic signal may be processed as to be represented on a polar plot with a spatial representation indicating characteristics of the signal, such representation having the shape of a lobe L with a central axis indicating the direction of greatest intensity and the shape of the lobe L indicating characteristics of the acoustic signal, such as intensity.

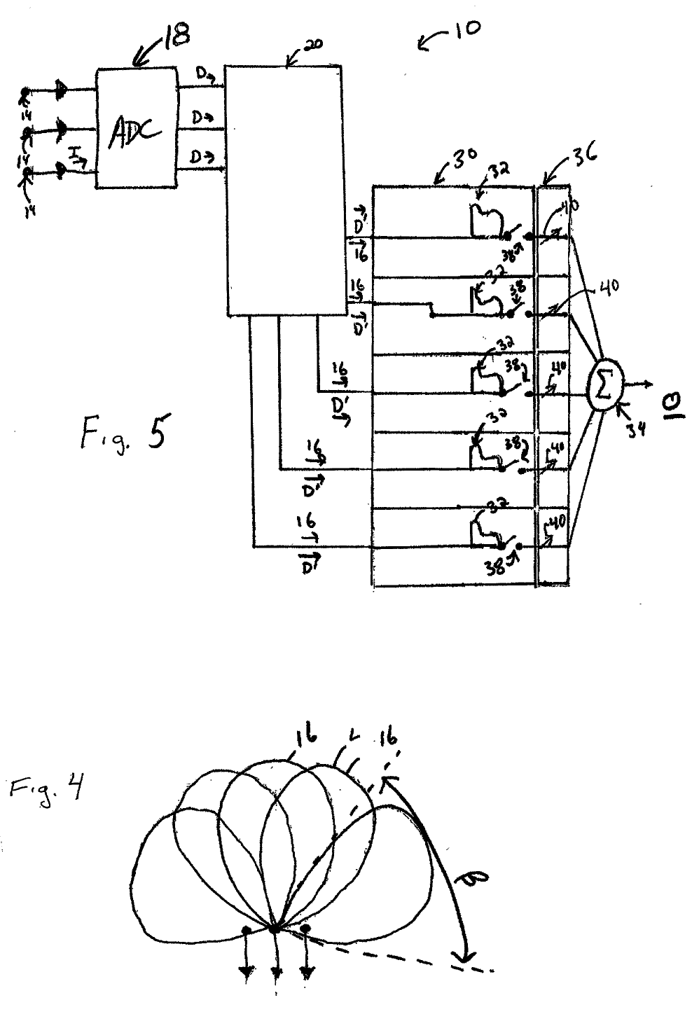

The system 10 includes a pickup or receiving capability represented as the microphone 12, principally being one (1) array microphone. The microphone 12 uses multiple transducers 14 to convert an acoustic signal into an electrical signal I. The invention includes the processing of multiple acoustic/audio sources directed at a single microphone 12 containing multiple transducers 14, or multiple transducer elements, each capable of receiving a separate acoustic signal. As used herein, a transducer 14 is device that reacts to acoustic vibrations thereby causing an electrical impulse through electric components. A transducer element, as used herein, is intended to be broader than a transducer and encompassing a device which creates an electrical impulse through electric components, a transducer element being broader than a transducer in the sense that multiple transducer elements may share certain electric components with other transducer elements to produce distinct and separate electrical impulses through electric components. Regardless of the combination or array of transducers employed, the audio signals received are analog signals. Each transducer 14 converts the sum of analog signals received to its own respective electrical signal I (see FIG. 5).

As depicted, the microphone 12 of the present invention has a particular orientation to the speakers S. However, it should be noted that the microphone 12 may be placed in a variety of places both proximally or distally, such as flown overhead or at the center of a table T, drastically reducing the visibility of microphones. The system 10 of the present invention may be used wherever multiple speakers S are or may be situated. Ideally, the speakers' S voices are directed toward the microphone 12.

As can be seen in FIG. 3, two speakers S each produce an acoustic signal that may be represented as lobe L. The acoustic signals are received by each of the transducers 14.

Referring now to FIG. 4, multiple lobes L are depicted as received by a transducer 14. Each lobe L is essentially a spatial representation of a beam 16, with a particular beamwidth β, as it would appear on a polar plot after being processed. The number of beams 16 is a function of the processing power of certain aspects of the system 10: specifically, the system of the present invention preferably utilizes a method and apparatus of digital signal processing (DSP), the power of which is dependent on its algorithms and processing power. The width of each beam (beamwidth) β is a function of applied physics and the digital signal processing.

Referring now to FIG. 5, the system 10 of the present invention is depicted. Each transducer 14 sends its respective electrical signal I to an analog to digital (A/D) converter 18, resulting in the electrical signal I being converted to a digital signal D. Each signal D is then sent through a beamformer 20.

Beamforming and beamsteering are performed by the beamformer 20 from the signals D. In the preferred embodiment, the beamformer 20 uses a buffer and delay. The system 10 stores the signals D in buffers in the beamformer 20, allowing the system 10 to select appropriately delayed signals to form steered beams 16. Each of the steered beams 16 is comprised of sound from a limited region of space. The buffer aspect of the beamformer 20 allows for simultaneously reading stored samples of the individual signals from memory. The system 10 processes these samples and adjusts the directional sensitivity for the beams 16, and does so in multiple directions thereby forming multiple beams 16. Each of the beams is exclusive of the other beams. These beams are sensitive to sound only in the direction to which the beam is steered while rejecting sound from other directions. Each signal D is processed to form a beam 16 that is separate from and is passed through the beamformer 20 mutually exclusively of the other beams 16. The beamformer 20 outputs signals D′, each being a beam 16 of a separate signal D′. The signals D′ are delay/sum beamformed signals, and are different from the signals D from the individual transducer elements.

The beamformer 20 uses signal superpositioning to form beams 16 by shading and attenuating the signals D. Beamforming is the creation of the beams 16 from a resulting pickup pattern from arranging and attenuating multiple individual beams 16 where the pickup pattern is highly sensitive in a particular direction while of low sensitivity in other directions. Furthermore, the beamformer 20 steers beams 16 by selecting an axis for each beam 16 based upon signal intensity in relation to location of the beam 16 on a polar plot, each beam 16 thus having a particular orientation or directional sensitivity.

Individual speakers S (human voices), create an acoustic signal that can be isolated as a distinct lobe L of an electrical signal I as the acoustic signal is received by the transducer 14. The principle behind this system 10 is that a plurality of beams 16 are formed in the beamformer 20. The delay aspect of the beamformer 20 allows the beamformer 20 to temporarily hold a signal D so that, once a beam 16 is recognized as containing a desirable characteristic such as the presence of speech, the beam 16 can be processed as a component of desired signal D.

As has been noted, multiple beams 16 are formed with their respective signals having a greatest intensity in respective multiple directions. The system 10 can make an immediate determination as to whether a beam 16 is desirable or not based upon the intensity of the desired signal from a beam 16 in its particular directional orientation. It should be noted that it is the signal in each beam that is considered to have an intensity. More appropriately, intensity is a reference to power, as used herein and in this meaning. Accordingly, the desired signal contains speech or is the speech itself, and the quality of the speech required for the algorithm to mix/switch beamformers is the time-dependent energy content (power) in the signal received by the beamformer. For instance, if a first beam 16 has a profile that is relatively small relative to the profile of a second beam 16, the system 10 may determine the first beam 16 is to be ignored as not containing any desirable signal other than echo or the like. Then, the system 10 may be used to determine which of the beams of suitable intensity (represented by the profile size) contain the desirable characteristic such as speech. Alternatively, all beams 16 may be analyzed, accepted, and rejected on the basis of the presence of speech. In a manner of speaking, a rejected beam 16 is “turned off” for not satisfying the criteria of the system 10, such as speech.

It is important that the system 10 differentiate between the separate lobes L so that the lobes L do not collapse as one lobe L that swings rapidly between the speakers. The processing of the system 10 decides if a desirable signal is present in a beam 16, and permits or forbids the signal to pass. If there is more than one person talking (more than one desirable signal in more than one beam 16), the automatic mixing permits the signal from two or more beams to pass and be mixed at the output. If the output were restricted to only one signal from a single beamformer, the beam with the dominant signal would be passed and all others rejected. Accordingly, the output signal would oscillate between the output of which ever beamformer has the dominant signal. The speech analysis is a rapid process with speech or other characteristics changing rapidly: time windows for analysis of the signal for a characteristic can vary from the order of 250 milliseconds to two or three seconds. As the output switched between different beams 16 from different beamformers 20, a listener would hear one or another talker only briefly. Accordingly, it is preferred that auto-mixing is applied to the processing in order to keep the multiple output beams on. In the preferred embodiment, this can be achieved by SCM 810 and Intellimix™ auto-mixing equipment as is manufactured by Shure Incorporated of Evanston, Ill., or can be accomplished using an automatic mixing algorithm on the microprocessor used as the beamformer 20 (executing the DSP system and algorithm).

How well a signal from a particular direction is picked up or received can be dependent on microphone construction, the sampling rate and processing power of the digital signal processor, and the CODEC used. Realizing these limitations, in processing the signal D, it can be determined from what direction a particular portion of the received signal D is sent. To most effectively process the desired beams, the present system 10 selects a steering angle so as to locate the center axis of the desired beam. The desired signal in one embodiment of the present invention is speech from a human speaker, while in others it may be noise from a particular direction or area of events which may or may not include speech. As is described above, the result of this process is beams that have a steered direction. In practical terms, this means that beams may be received in any number of directions and beam patterns may vary in coverage angle. A number of manners are available for forming beams and different signal processing methods are available.

In practicing the present invention in different aspects, determination or selection of the precise angle of beamformer is more complex. Using phase delays via a frequency domain beamoformer, the precise angle of a beamformer can be selected. However, in the preferred embodiment using time domain beamforming, steering angles are fixed to the synchronous beams by fixed DSP sampling periods and, thus, fixed delays. Therefore, in time domain beamforming, no steering angle selection is possible, instead operating with a set of fixed angles allowed by the hardware, software, and power of the delays.

As has been noted, the beams 16 are analyzed for the presence of human speech. The beamformer 20 sends the beams 16 to a speech detection processor 30 to determine if the signal D′ is comprised of speech and, thus, a desired signal. As discussed above, the signals D are processed in parallel to form beams 16 and signals D′, each beam 16 treated as a single input to an N input mixing algorithm where N can be any number equal to or exceeding 1. The algorithm uses a short versus long time averaging process for determining whether speech exists on any one of the N input channels. Short-term averaging durations are approximately the duration of a human speech phenome, approximately 250 milliseconds. However, other methods of recognizing the presence of speech in the signals D′ may be used.

The processed signals D′ are sent to a logic block 32. The logic block 32 makes a decision as to whether speech is present in the signal D′ (speech detection, or speech detection processing, in the manner discussed above) and as to the location of the speaker S. If speech is not present, the logic block 32 discards the signal D′ by not allowing the signal D′ to pass.

The pick up of signals D can be dependent on characteristics of the transducer 14 and on the signal D itself. For instance, low frequency signals may not be picked up as well as signals of a higher frequency, or vice versa. When dealing with human voices that are received by a microphone, this can be an issue. As an example, if multiple speakers have voices or make sounds ranging widely in frequency, the response or pick up by a microphone or transducer can be such that certain voice signals are hidden by the intensity of other voice signals. Accordingly, one manner in which this problem can be overcome is with mixing of the signals by a mixer 36. Once a signal D′ has been identified as containing speech, the mixer 36 determines the level, or strength of signal, that is to be passed. As depicted, the mixer 36 is based on a plurality of potentiometers 40 which determine the level to be passed based on logic and the number of open channels.

It should be noted that there are two alternatives for mixing of the signals by the mixer 36. The beamformer 20 forms the beams 16 through a digital signal processing (DSP) hardware, method and algorithm. In one, preferred alternative, the logic block 32 further includes an implementation of automixing (represented as mixer 36) such that logic block 32 and 36 are co-located and co-performed as a DSP implementation (performed by the same code). In a second alternative, separate signals D′ are routed from the beamformer 20 to an external automatic mixer, such as SCM 810 and Intellimix™ auto-mixing equipment manufactured by Shure Incorporated of Evanston, Ill., or similar type automixing/detection hardware/device/algorithm. However, in an external automatic mixer, the mixing 36 and logic block 32 steps are performed by the same device (circuitry) such as an SCM810. It should be noted that both alternatives could be implemented concurrently, but it is not preferred or recommended.

In the present embodiment, mixing is applied to all the signals D′ by the mixer 36. This ensures that all the signals are passed in such a manner that signals D′ containing voice are not lost, or drowned out by signals which the electronics and circuitry of the present system would normally process as having a greater intensity or volume. The signals D′ that are passed are then summed as an output O as at 34.

The formed beams 16 containing talkers are mixed using on-board digital signal processing. Accordingly, the multiple talkers benefit from noise rejection afforded by being located in an array beam (such as is produced by an array microphone). In other words, the benefits of a tight beam which rejects ambient effects such as reverb and echo can be simultaneously directed at multiple speakers S, eliminating unwanted noise from angles (directions) other than those from which the speaker(s) S is/are speaking.

Each signal D′ requires a channel 38 in the mixer 36, or memory on logic block 32. As discussed above, the mixing is preferably auto-mixing providing that channels 38 remain open to prevent the pick-up of the beam 16 from swinging between speakers S. In conjunction with the speech detection, the system 10 then can treat each beam 16 as a single open or closed microphone: in the case of a lack of speech, the logic block 32 shuts off the signal D′. The mixer 36 provides a specific number of output channels 38, and the system's 10 ability to produce separate signals requiring an output channel 38 is strictly a function of the processing power of the DSP and the available output channels on the DSP platform. The system 10 may be programmed for on-board auto-mixing, thereby allowing for comparable intelligent processing of conferencing output on a single hardware/software platform, or system. In some cases, a sound engineer may be eliminated. The logic block 32 may implement additional processing such as gain management of mixed signals D′ based on the number of beams mixed for output.

There are numerous other applications for the present invention. For instance, the system 10 may be used at sporting events where a microphone 12 is located at a particular point along a playing area such that audio from the action at multiple areas within the playing area may be auto-mixed while removing crowd or other noise. In this instance, speech detection processing may or may not be necessary depending on the audio that one desires to pick up. Another application is in a theater with a stage, where multiple players may be speaking or playing instruments and auditorium reverb and echo are eliminated. In other words, the system 10 creates multiple, simultaneous beam signals and allows these to pass based upon whether they are desirable, most particularly whether they are desirable due to the presence of speech though other characteristics may be selected.

As an alternative implementation, the speech detection algorithm may be bypassed. Instead, the signals may be diverted for input into a mixer as recognized beams that are desired to be a portion of the output of the present invention. In the preferred embodiment, this can be achieved by SCM 810 and Intellimix™ auto-mixing equipment manufactured by Shure Incorporated of Evanston, Ill., or similar type automixing/detection hardware/device/algorithm.

As various changes could be made in the above constructions without departing from the scope of the invention, it is intended that all matter contained in the above description or shown in the accompanying drawings shall be interpreted as illustrative and not in a limiting sense.

1. A system for receiving and processing multiple input signals and outputting signals with only a desired characteristic comprising:
a microphone including multiple transducer elements wherein each transducer element produces a separate electrical signal;
a buffer wherein the electrical signals are stored temporarily;
a beamformer wherein the electrical signals are formed into a plurality of mutually exclusive signal beams;
a desired characteristic detector; and
a mixer.

2. The system of claim 1 wherein said multiple input signals are acoustic signals.

3. The system of claim 1 further including an analog-to-digital converter.

5. The system of claim 1 wherein said characteristic detector includes a logic block that selects which signal beams are output.

6. The system of claim 5 wherein said characteristic detector is a speech detection processor.

7. The system of claim 6 wherein such signals are selected based upon the presence of speech in the signal beams.

8. The system of claim 7 wherein the speech detection processor uses a short versus long time averaging process for determining whether speech exists in a signal beam.

9. The system of claim 1 wherein the output signal beams have a directional orientation relative to the microphone.

10. The system of claim 1 wherein the mixer auto-mixes the desired beams prior to output.

11. A method for isolating and processing multiple desired acoustic signals:
receiving input signals with a microphone, said microphone including multiple transducer elements;
converting said input signals to electrical signals;
storing temporarily said electrical signals in a buffer;
forming multiple mutually exclusive beams from said stored electrical signals;
selecting desired beams from said beams; and
outputting said desired beams.

12. The method of claim 11 further including the step of converting said electrical signals into digital signals.

13. The method of claim 11 wherein the step of selecting desired beams from said beams includes analyzing the beams for a specified characteristic.

14. The method of claim 13 wherein the specified characteristic is the presence of speech.

15. The method of claim 13 wherein the step of analyzing the desired beams includes first analyzing the beams for intensity of the beam and second analyzing the beams for the presence of speech.

16. The method of claim 15 further including the step of mixing the desired beams prior to said step of outputting.
